(19) United States
(12) Patent Application Publication
(10) Pub. No.: US 2020/0009772 A1
(43) Pub. Date: Jan. 9, 2020

(54) DEVICE AND PROCESS FOR MANUFACTURING A COMPONENT FORMED OF A PLURALITY OF MOLDINGS MADE OF PLASTIC AND WELDED TOGETHER

(71) Applicants: Gebr. Krallmann GmbH, Hiddenhausen (DE); Woco Industrietechnik GmbH, Bad Soden-Salmünster (DE)

(72) Inventors: Ingo BREXELER, Wetter/Ruhr (DE); Anton WOLF, Gelnhausen (DE)

(21) Appl. No.: 16/458,840

(22) Filed: Jul. 1, 2019

(30) Foreign Application Priority Data
Jul. 3, 2018 (DE) 10 2018 005 227.4

(51) Int. Cl. B29C 45/00; B29C 45/06; B29C 45/16

(52) U.S. Cl. CPC B29C 45/0013; B29C 45/062; B29C 2045/1601; B29C 45/1657; B29C 45/1642

(57) ABSTRACT

For manufacturing a component formed of a plurality of moldings, which are made of plastic, are welded together. A first molding is manufactured in a first mold that has a first mold part and is then transported with the first mold part into a welding station. Correspondingly, a second molding is manufactured in a second mold that has a second mold part and is transported with the second mold part into the welding station. The mold parts holding the moldings are moved towards one another in the welding station such that the moldings are welded together. Additional moldings are manufactured in the molds simultaneously with the welding of the moldings.

### CROSS REFERENCE TO RELATED APPLICATIONS

This application claims the benefit of priority under 35 U.S.C. § 119 of German Application 10 2018 005 227.4, filed Jul. 3, 2018, the entire contents of which are incorporated herein by reference.

### TECHNICAL FIELD

The present invention pertains to a device for manufacturing a component formed of a plurality of moldings (molded bodies) which are made of plastic and are welded together, with a first mold that has a first mold basic segment and at least one first mold part, which can be shifted in relation to one another and form between them a first molding cavity, and with a second mold that has a second mold basic segment and at least one second mold part, which can be shifted in relation to one another and form between them a second molding cavity.

Moreover, the present invention pertains to a process for manufacturing a component formed of a plurality of moldings which are made of plastic and are welded together, and two moldings made of plastic are injected and then welded together to form the molding.

### TECHNICAL BACKGROUND

In particular, so-called thermal management modules, for example, for the cooling and temperature regulation of batteries or of electric motors or of other electronic devices are becoming increasingly important in automotive technology, aeronautical technology or medical technology. Electronic devices are becoming increasingly more efficient and/or smaller, as a result of which the thermal stress of the electronic devices is increased. A continuously elevated operating temperature reduces the service life and efficiency of the electronic devices. A good thermal management, for example, by means of water cooling helps to protect the electronic devices and to increase their efficiency.

Using moldings made of plastic as a base plate for, for example, water guides, in or at which valve bodies and sensor elements are mounted, is known. The moldings usually form half shells, on the surfaces of which are formed a plurality of walls and grooves that interact each with corresponding walls and grooves of the other half shell to form cooling ducts. The moldings forming the half shells are usually injection molded from plastic, especially polypropylene and are reinforced with embedded glass fibers. The moldings have a highly contoured surface, which creates the problem that the moldings shrink nonuniformly and frequently warp during the cooling off after the injection molding process. It is not possible with such deformed moldings to place them precisely on one another and to weld them together.

### SUMMARY

A basic object of the present invention is to provide a device for manufacturing a component formed of a plurality of moldings (molded bodies) which are made of plastic and are welded together, in which process the moldings can be welded to the component with high accuracy.

Moreover, a process shall be provided according to the present invention, with which the moldings can be welded to the component in a rapid and cost-effective manner.

The above-mentioned object is accomplished by a device according to the present invention. Provisions are made here for the first mold to have a plurality of first mold parts of the same kind that can be brought selectively and one after another into contact with the first mold basic segment for forming the first molding cavity, for the second mold to have a plurality of second mold parts of the same kind that can be brought selectively and one after another into contact with the second mold basic segment for forming the second molding cavity, for at least one welding station to be provided, for the first mold parts of the first mold to be shiftably mounted (in a shiftable manner) on a first support structure and to be able to be shifted between a position in the first mold and a position in the welding station, for the second mold parts of the second mold to be shiftably mounted (in a shiftable manner) on a second support structure and to be able to be shifted between a position in the second mold and a position in the welding station, and for one of the first mold parts of the first mold and one of the second mold parts of the second mold to be able to be moved towards one another and away from one another in relation to one another in the welding station by means of at least one drive device such that a plurality of moldings can be welded to the component between the first mold part and the second mold part.

The present invention is based on the fundamental consideration to provide a device with at least one injection molding unit and at least one welding unit, which can be controlled independently of one another. Moldings manufactured in the molds of the injection molding unit are welded together in a welding station immediately after the manufacturing or injection molding process rather than be removed from the device and cooled. In this case, the welding station may be integrated into the device. The heat energy contained in the moldings is thus also simultaneously used for the welding process, and the warping or uncontrolled shrinking of the moldings during the cooling is avoided.

Due to the use of a plurality of first mold parts of the same kind and a plurality of second mold parts of the same kind and because of their shiftability between the corresponding mold and the welding station, it is possible to inject the moldings into the molds and at the same time to weld together the moldings manufactured in the previous cycle in the welding station.

The moldings are manufactured in the molds. After opening the molds, the moldings are preferably held in the first mold part and in the second mold part. The two mold parts are then shifted and in particular displaced together with the moldings from the mold into the welding station. At the same time, an available, additional first mold part is inserted into the first mold and an available, additional second mold part is inserted into the second mold. It is possible in this manner to weld the moldings together preferably in their state held in the mold parts and at the same time already to inject new moldings into the molds.

In order to hold the molding securely during the transfer process and during the welding process, the mold part holding the molding may be configured as a so-called cassette.

In a variant of the present invention, two welding stations may be provided, which may be arranged, for example, on opposite sides of the molds, so that the first mold parts and the second mold parts are preferably moved in an alternating shifting movement between the first welding station, the corresponding mold and the second welding station as well as correspondingly back.

Provisions are preferably made for the first mold basic segment of the first mold and for the second mold basic segment of the second mold to be arranged at a common mold block, through which the plastic melt may also preferably be fed for the injection molding process. If two welding stations are provided, these may be arranged on the opposite sides of the mold block.

A heating device may be provided in the welding station for the moldings and in particular for their opposite contact surfaces in order to heat the moldings again in case the heat energy available in the moldings is not sufficient for welding together the moldings. The heating device may be a so-called heating mirror, i.e., a heated, preferably plate-shaped component, which is positioned close to the moldings and heats same. As an alternative or in addition thereto, the heating device may operate by infrared and/or ultrasound and/or by a hot gas and/or by contact heating as well.

When a plurality of welding stations are provided, a separate heating device may be associated with each welding station. As an alternative, it is also possible, however, to provide only a single heating device and to transfer this [heating device] between the individual welding stations by means of a transfer device, for example, a robot.

Built-in elements, for example, valves or sensors or fastening elements which are then permanently integrated by welding into the component formed from the moldings may be positioned at the moldings before the welding thereof in the welding station.

The process according to the present invention for manufacturing a component formed of a plurality of moldings which are made of plastic and are welded together is characterized by the following steps:

A first molding is manufactured by injection molding in a first mold that has a first mold part and is transported together with the first mold part into a welding station after opening the first mold in a state held in the first mold part. A second molding is manufactured by injection molding in a second mold that has a second mold part and is transported together with the second mold part into the welding station after opening the second mold in a state held in the second mold part.

The two moldings are preferably manufactured in the molds at the same time.

The first mold part holding the first molding and the second mold part holding the second molding are moved towards one another in relation to one another in the welding station by means of a drive device such that the moldings are welded to a component between the first mold part and the second mold part. In this case, the moldings are brought into contact with one another and pressed against one another, the residual heat contained in the moldings being utilized to carry out or at least support the welding process. In this case, the movements of the drive device are independent of the opening and closing motion of the molds. One or more hydraulic piston-and-cylinder units are provided as the drive device.

In case the residual heat that is contained in the moldings is not sufficient to achieve a welding of the moldings, provisions may be made for the moldings to be heated by means of a heating device before the welding at least in the opposite contact surfaces. The heating device may have the configuration mentioned above.

Provisions are preferably made for an additional first molding to be manufactured in the first mold and for an additional second molding to be manufactured in the second mold simultaneously with the welding of the moldings in the welding station.

A manufacturing cycle of a component is described below in detail in order to explain both the device according to the present invention and the process according to the present invention in more detail:

First, the device is in its starting position. The molds are opened and the additional first mold part as well as the additional second mold part are located in the second welding station. The molds are then closed by the second support structure being displaced in the direction of the first support structure. The sub-cavities form the first molding cavity in the first mold and the second molding cavity in the second mold. A liquid plastic compound is then filled through the mold block into the molding cavities.

After a reasonable waiting time, during which the plastic compound partially solidifies, the molds are opened by the second support structure being shifted in relation to the first support structure. The moldings formed in the molds are held in the first mold part and in the second mold part when the molds are opened. The two first mold parts are then displaced along the first support structure. In this case, the first mold part carrying the first molding is transported from the first mold into the first welding station, and at the same time the additional first mold part is shifted from the second welding station into the first mold located directly opposite the first mold basic segment. At the same time, the two second mold parts are displaced along the second support structure. In tis case, the second mold part carrying the second molding is transported from the second mold into the first welding station and at the same time the additional second mold part is shifted from the second welding station into the second mold located directly opposite the second mold basic segment.

The first support structure and the second support structure are now moved towards one another, as a result of which the molds are closed again. The first mold part with the first molding and the second mold part with the second molding are located at mutually spaced locations in the first welding station. A heating device, for example, in the form of a thin heating plate, is inserted between these two moldings.

The drive devices associated with the first heating station (welding station) are then activated such that the first mold part and the second mold part are moved towards one another to the extent that the moldings held by them are either arranged very close to the heating device or are in contact with same. As a result, the moldings are heated and especially melted at least at the surfaces facing one another, at which they come into contact with one another during the later welding process.

After the moldings are sufficiently heated, the heating device is removed or moved out and the first mold part and the second mold part are moved even further towards one another by means of the drive devices until the two moldings are pressed against one another and are welded together. At the same time, an additional first molding is manufactured in the first mold and an additional second molding is manufactured in the second mold by the liquid plastic compound being fed in.

The drive devices are then again returned, so that the first mold part and the second mold part are again located in their positions close to the first support structure and the second support structure, respectively. At the same time, the molds are moved apart from one another and opened. The component B formed from the welded moldings is thus now accessible and can be removed.

The additional molding manufactured in the first mold is held at the additional first mold part and the additional molding manufactured in the second mold is held at the additional second mold part. The first mold parts are shifted in relation to the first support structure such that the additional first mold part is shifted from the first mold into the second welding station and the first mold part is shifted from the first welding station into the first mold.

Correspondingly, the additional second mold part is shifted with the molding from the second mold into the second welding station and the second mold part is shifted from the first welding station into the second mold part.

The first support structure and the second support structure are now moved towards one another, as a result of which the molds are closed again. The additional first mold part with the first molding and the additional second mold part with the second molding are located at mutually spaced locations in the second welding station. A heating device, for example, in the form of a thin heating plate, is inserted between these two moldings.

The drive devices associated with the second heating station (welding station) are then activated such that the additional first mold part and the additional second mold part are moved towards one another to the extent that the moldings held by them are either arranged very close to the heating device or are in contact with this heating device. Consequently, the moldings are heated and especially melted at the surfaces facing one another, at which they come into contact with one another during the later welding process.

After the moldings have been sufficiently heated, the heating device is removed or moved out and the additional first mold part and the additional second mold part are moved even further towards one another by means of the drive devices until the two moldings are pressed against one another and are welded together. At the same time, an additional first molding is manufactured in the first mold and an additional second molding is manufactured in the second mold by the liquid plastic compound being fed in.

The drive devices are then moved back again, so that the additional first mold part and the additional second mold part are again located in their positions close to the first support structure and the second support structure, respectively. At the same time, the molds are moved apart from one another and opened. The component formed from the welded moldings is thus now accessible and can be removed.

Additional details and features of the present invention appear from the following description of an exemplary embodiment with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a device according to the present invention in a starting position;

FIG. 2 is a schematic view showing the device according to FIG. 1 with closed molds;

FIG. 3 is a schematic view showing the device according to FIG. 2 after manufacturing the moldings;

FIG. 4 is a schematic view showing the device according to FIG. 3 after transferring the moldings into the first welding station;

FIG. 5 is a schematic view showing the device according to FIG. 4 after closing the molds again and inserting a heating device;

FIG. 6 is a schematic view showing the device according to FIG. 5 during the heating of the moldings;

FIG. 7 is a schematic view showing the device according to FIG. 6 during the welding of the moldings and during the manufacture of additional moldings;

FIG. 8 is a schematic view showing the device according to FIG. 7 with open molds and open welding station;

FIG. 9 is a schematic view showing the device according to FIG. 8 after transferring the additional moldings into the second welding station;

FIG. 10 is a schematic view showing the device according to FIG. 9 after closing the molds again and inserting a heating device;

FIG. 11 is a schematic view showing the device according to FIG. 10 during the heating of the moldings;

FIG. 12 is a schematic view showing the device according to FIG. 11 during the welding of the moldings and during the manufacture of additional moldings; and

FIG. 13 is a schematic view showing the device according to FIG. 12 with open molds and open welding station.

### DESCRIPTION OF PREFERRED EMBODIMENTS

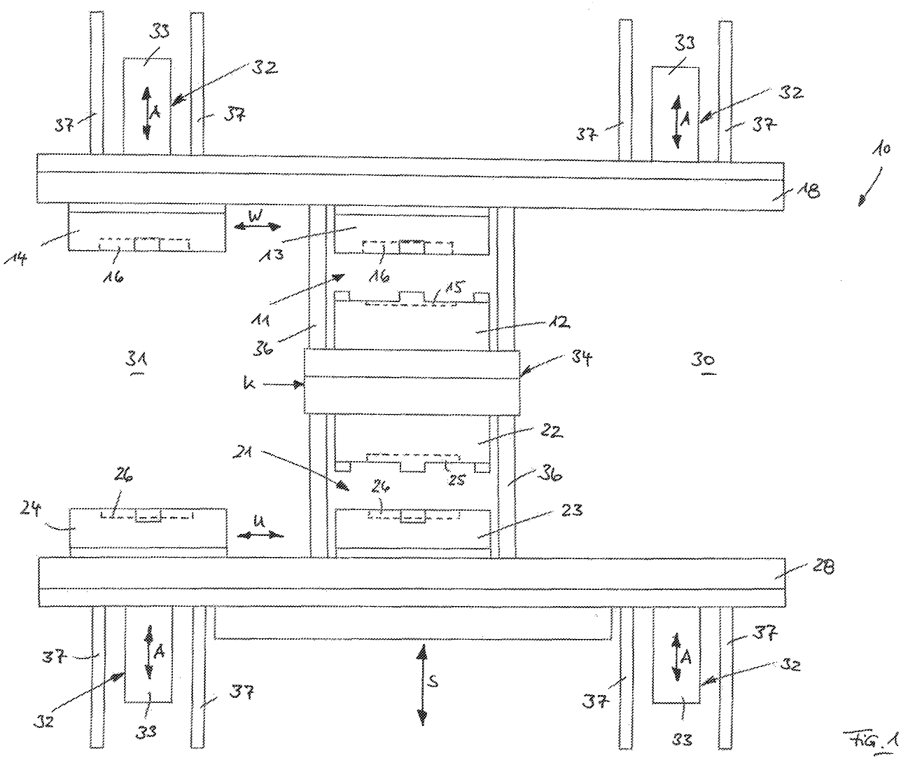

Referring to the drawings, FIG. 1 shows a schematic view of a device 10. The device 10 has a first support structure 18 that has an essentially plate-shaped configuration in the exemplary embodiment being shown. A second support structure 28 of the same kind is provided at a distance and essentially parallel thereto. The two support structures 18 and 28 may be shifted in relation to one another such that their mutual spacing is reduced or increased, as is suggested by the double arrow S.

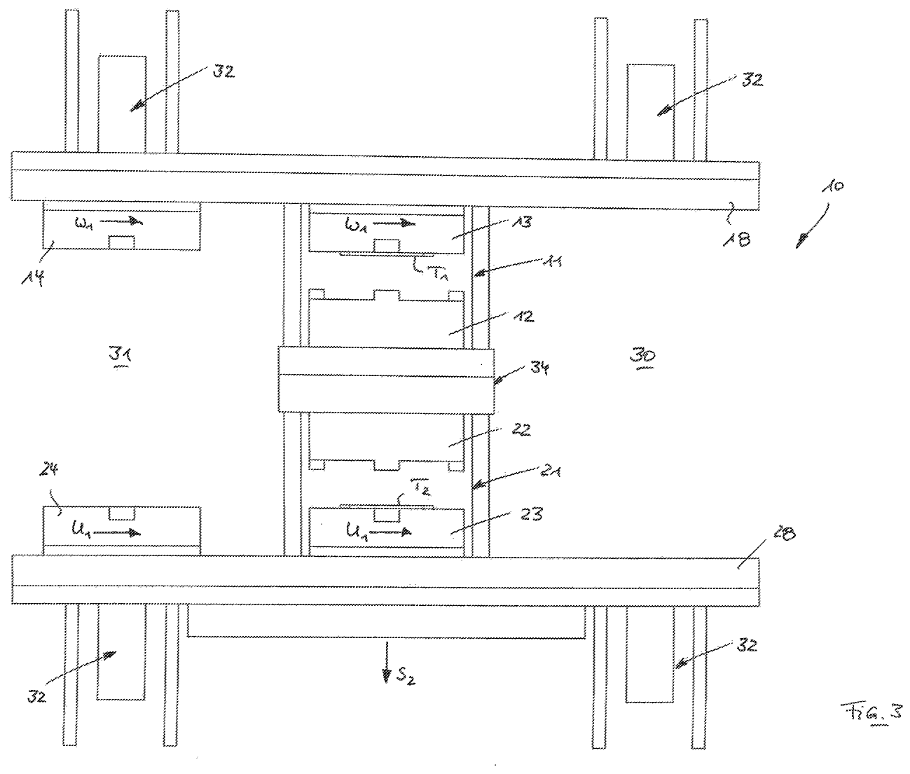

A first mold 11 for the injection molding of a first molding T1 (see FIG. 3) and a second mold 21 for the injection molding of a second molding T2 (see FIG. 3) are arranged between the two support structures 18 and 28. A common, middle mold block 34, through which plastic melt can be fed to the molds 11 and 21, as is suggested by the arrow K, is associated with the two molds 11 and 21.

Linear guides 36, which are used to guide the mold block 34 and the molds 11 and 21 during the relative shifting between the first support structure 18 and the second support structure 28, extend between the first support structure 18 and the second support structure 28.

The first mold 11 has a first mold basic segment 12, which is arranged on the mold block 34, and a first mold part 13, which is located opposite the first mold basic segment 12 and can be shifted in relation to same, so that the first mold 11 can be opened and closed in the known manner.

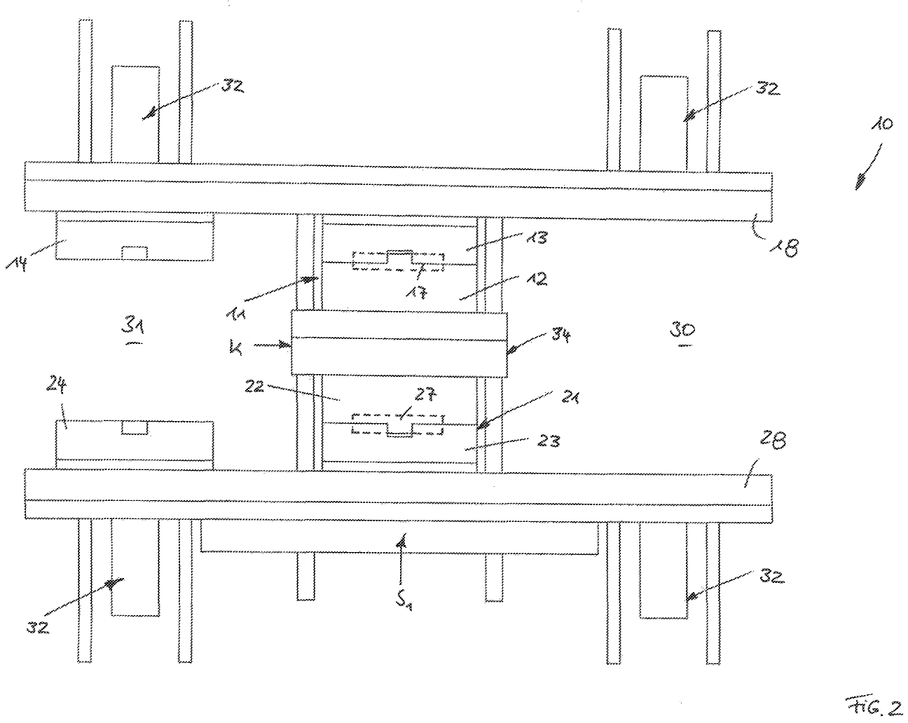

The first mold basic segment 12 has a sub-cavity 15 on its side facing the first mold part 13. The first mold part 13 likewise has a sub-cavity 16 on its side facing the first mold basic segment 12. The two sub-cavities 15 and 16 form a first molding cavity 17 in the closed state of the first mold 11 (see FIG. 2).

As FIG. 1 shows, the first mold 11 comprises an additional first mold part 14 of the same kind. The two first mold parts 13 and 14 may be shifted and displaced as a unit especially at an angle to the closing direction of the first mold 11, as it is suggested by the double arrow W. It is possible in this manner to arrange either the first mold part 13 or selectively the additional first mold part 14 within the first mold 11 and thus located opposite the first mold basic segment 12.

A welding station 30, whose function will be explained later, is configured on the right side of the molds 11 and 21 according to FIG. 1 and between the first support structure 18 and the second support structure 28.

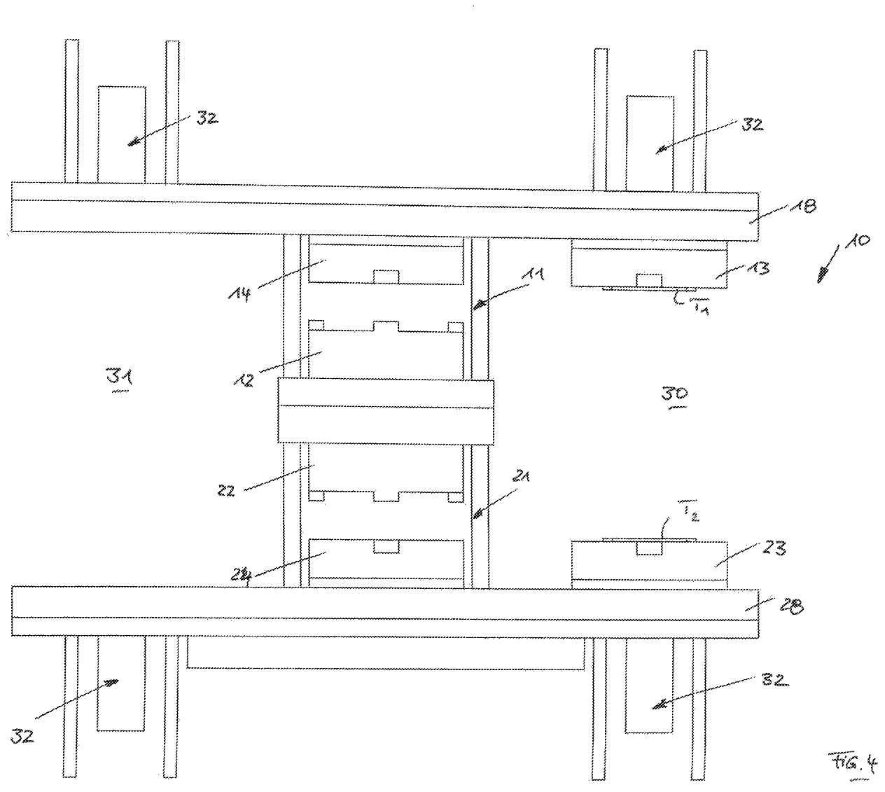

A second welding station 31, whose function will likewise be explained later, is provided on the opposite left side of the molds 11 and 21 according to FIG. 1. In the position shown in FIG. 1 of the first mold parts 13 and 14, the first mold part 13 is located in the first mold 11 located opposite the first mold basic segment 12, while the additional first mold part 14 is arranged in the second welding station 31. When the two first mold parts 13 and 14 are displaced, the first mold part 13 is displaced from the first mold 11 into the first welding station and at the same time the additional first mold part 14 reaches the first mold 11 located opposite the first mold basic segment 12 from the second welding station 31. This state is shown in FIG. 4.

The second mold 21 has a second mold basic segment 22, which is arranged on the mold block 34, and a second mold part 23, which is located opposite the second mold basic segment 22 and can be shifted in relation to same, so that the second mold 21 can be opened and closed in the known manner.

The second mold basic segment 22 has a sub-cavity 25 on its side facing the second mold part 23. The second mold part 23 likewise has a sub-cavity 26 on its side facing the second mold basic segment 22. The two sub-cavities 25 and 26 form a second molding cavity 27 in the closed state of the second mold 21 (see FIG. 2).

As FIG. 1 shows, the second mold 21 comprises an additional second mold part 24 of the same kind. The two second mold parts 23 and 24 may be shifted and displaced as a unit especially at an angle to the closing direction of the second mold 21, as it is suggested by the double arrow U. It is possible in this manner to arrange either the second mold part 23 or selectively the additional second mold part 24 within the second mold 21 and thus located opposite the second mold basic segment 22.

In the position shown in FIG. 1 of the second mold parts 23 and 24, the second mold part 23 is located in the second mold 21 located opposite the second mold basic segment 22, while the additional second mold part 24 is arranged in the second welding station 31. When the two second mold parts 23 and 24 are displaced, the second mold part 23 is displaced from the second mold 21 into the first welding station 30 and at the same time the additional second mold part 24 reaches the second mold 21 located opposite the second mold basic segment 22 from the second welding station 31. This state is shown in FIG. 4.

When the additional first mold part 14 is located in the second welding station 31, as it is shown in FIG. 1, it comes into active connection with a drive device 32 in the form of a hydraulic piston-and-cylinder unit 33, which is arranged at the first support structure 18. The additional first mold part 14 can be shifted by means of the drive device 32 in the direction of the second support structure 28, as it is suggested by the double arrow A. The additional first mold part 14 is guided at linear guides during this shifting movement.

A corresponding drive device 32 is also provided at the first support structure 18 for the first mold part 13 in the first welding station 30.

Corresponding drive devices 32 are also provided for the second mold parts 23 and 24 in the first welding station 30 and in the second welding station 31.

When the additional first mold part 14 and the additional second mold part 24 are located in the second welding station 31 in the manner shown in FIG. 1, they can be moved towards one another by means of the drive devices 32 to the extent that the mold parts 14 and 24 either are very close to one another or even touch. The same applies to the first mold part 13 and the second mold part 23 in the first welding station 30.

A cycle for manufacturing a component formed of a plurality of moldings, which are made of plastic and are welded together, is explained below in individual phases:

According to FIG. 1, the device 10 is in the starting position. The molds 11 and 12 are open and the additional first mold part 14 as well as the additional second mold part 24 are located in the second welding station 31. The molds 11 and 12 are then closed by the second support structure 28 being displaced in the direction of the first support structure 18 (arrow S1 in FIG. 2). The sub-cavities 15 and 16 form the first molding cavity 17 in the first mold 11 and the sub-cavities 25 and 26 form the second molding cavity 27 in the second mold 21. A liquid plastic compound is then filled through the mold block 34 into the molding cavities 17 and 27, as it is suggested by the arrow K.

After a reasonable waiting time, during which the plastic compound partially solidifies, the molds 11 and 21 are opened by the second support structure 28 being shifted in relation to the first support structure 18, as it is suggested by the arrow S2 in FIG. 3. The moldings T1 and T2 formed in the molds 11 and 21 are held in the first mold part 13 and in the second mold part 23, respectively, when the molds 11 and 21 are opened, as it is shown in FIG. 3. The two first mold parts 13 and 14 are then displaced along the first support structure 18, as it is suggested by the arrows W1. In this case, the first mold part 13 carrying the first molding T1 is transported from the first mold 11 into the first welding station 30, and at the same time the additional first mold part 14 is shifted from the second welding station 31 into the first mold 11 located directly opposite the first mold basic segment 12. At the same time, the two second mold parts 23 and 24 are displaced along the second support structure 28, as it is suggested by the arrows U1. In this case, the second mold part 23 carrying the second molding T2 is transported from the second mold 21 into the first welding station 30 and at the same time the additional second mold part 24 is shifted from the second welding station 31 into the second mold 21 located directly opposite the second mold basic segment 22. This state is shown in FIG. 4.

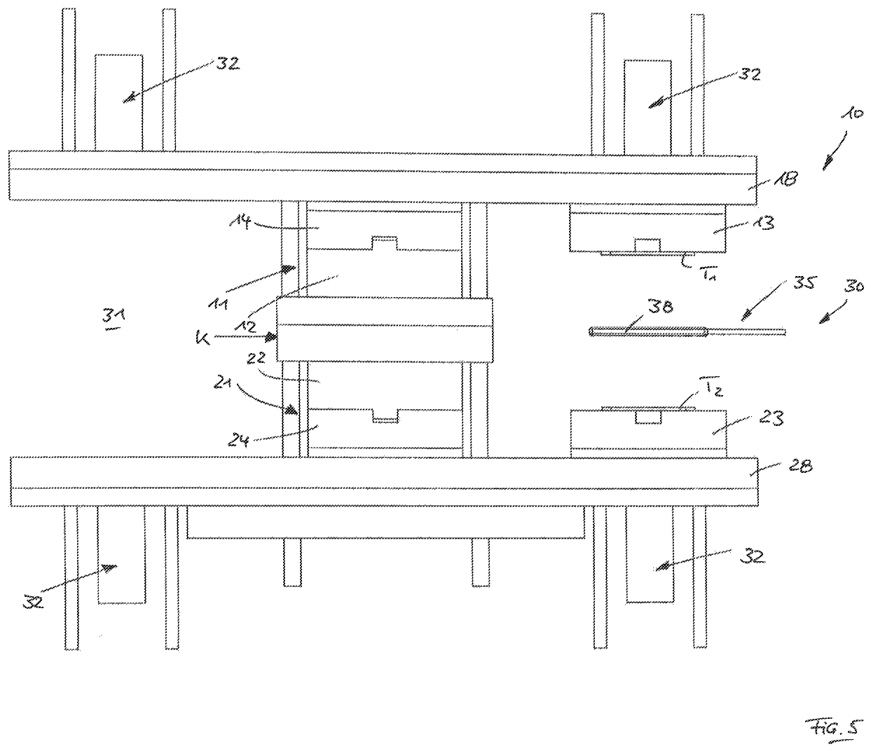

The first support structure 18 and the second support structure 28 are now moved towards one another, as a result of which the molds 11 and 21 are closed again. The first mold part 13 with the first molding T1 and the second mold part 23 with the second molding T2 are located at mutually spaced locations in the first welding station 30. A heating device 35 in the form of a thin heating plate 38 is inserted between these two molds 13 and 23 and between the two moldings. This state is shown in FIG. 5.

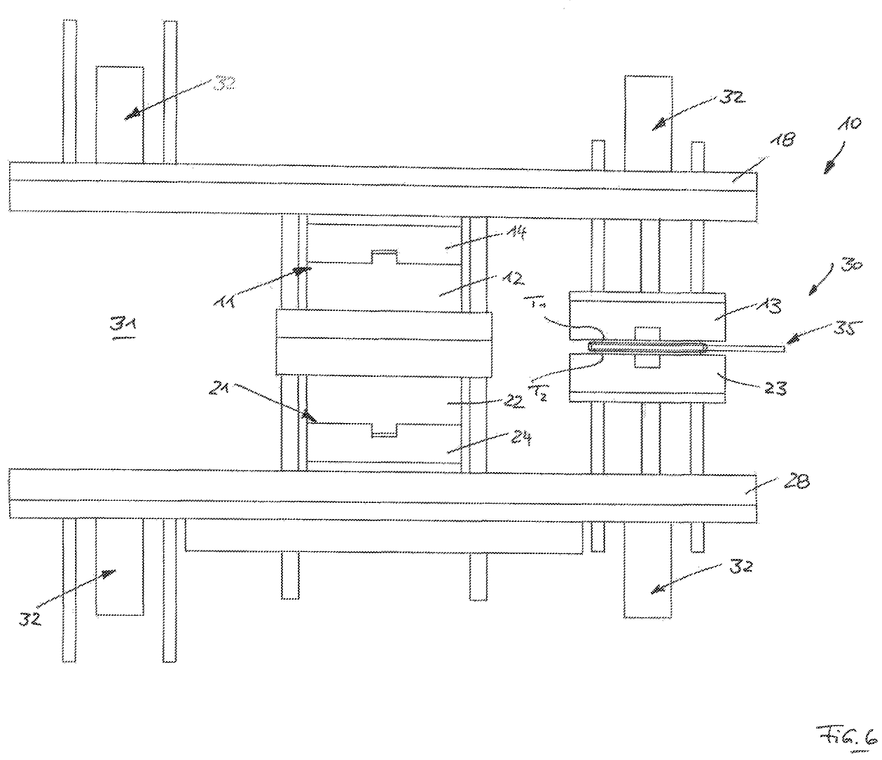

The drive devices 32 associated with the first welding station (heating station) 30 are then activated such that the first mold part 13 and the second mold part 23 are moved towards one another to the extent that the moldings T1 and T2 held by them are either arranged very close to the heating device 35 or are in contact with this heating device (FIG. 6). Consequently, the moldings T1 and T2 are heated and especially melted at least at the surfaces facing one another, at which they come into contact with one another during the later welding process.

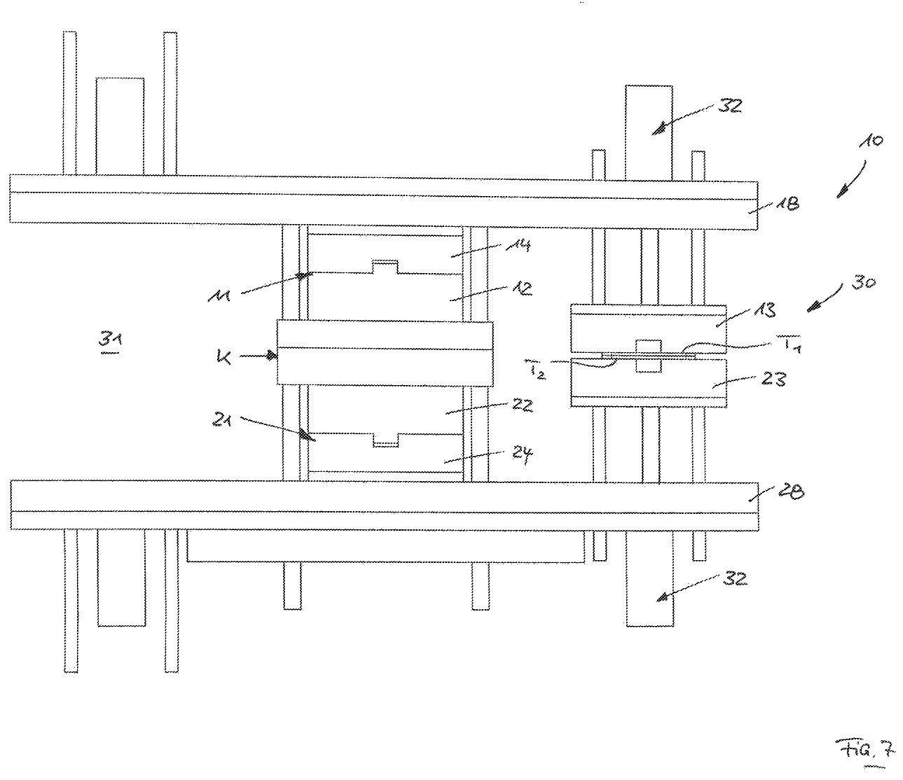

After the moldings T1 and T2 are sufficiently heated, the heating device 35 is removed or moved out and the first mold part 13 and the second mold part 23 are moved even further towards one another by means of the drive devices 32 until the two moldings T1 and T2 are pressed against one another and are welded together. This state is shown in FIG. 7. At the same time, an additional first molding is manufactured in the first mold 11 and an additional second molding is manufactured in the second mold 21 by the liquid plastic compound being fed in, as it is suggested by the arrow K in FIG. 7.

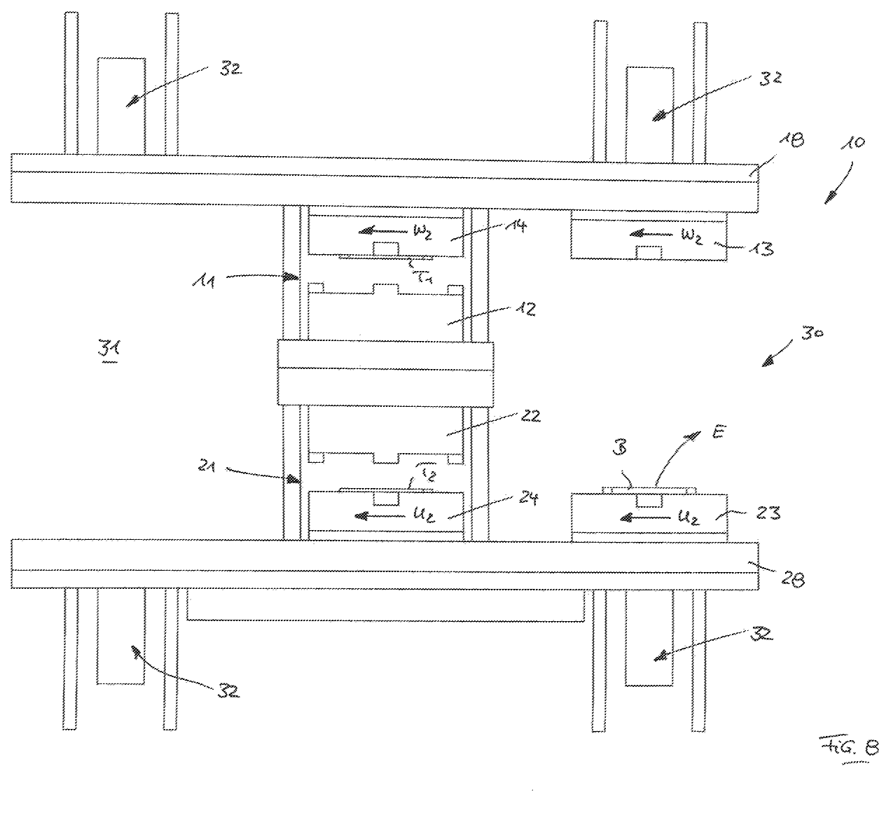

The drive devices 32 are then moved back again, so that the first mold part 13 and the second mold part 23 are again located in their position close to the first support structure 18 and the second support structure 28, respectively. At the same time, the molds 11 and 21 are moved apart from one another and opened. As FIG. 8 shows, the component B formed from the welded moldings is now accessible and can be removed, as it is suggested by the arrow E.

The additional molding T1 manufactured in the first mold 11 is held at the additional first mold part 14 and the additional molding T2 manufactured in the second mold 21 is held at the additional second mold part 24. The first mold parts 13 and 14 are shifted in relation to the first support structure 18 (see arrows W2 in FIG. 8) such that the additional first mold part 14 is shifted from the first mold 11 into the second welding station 31 and the first mold part 13 is shifted from the first welding station 30 into the first mold 11.

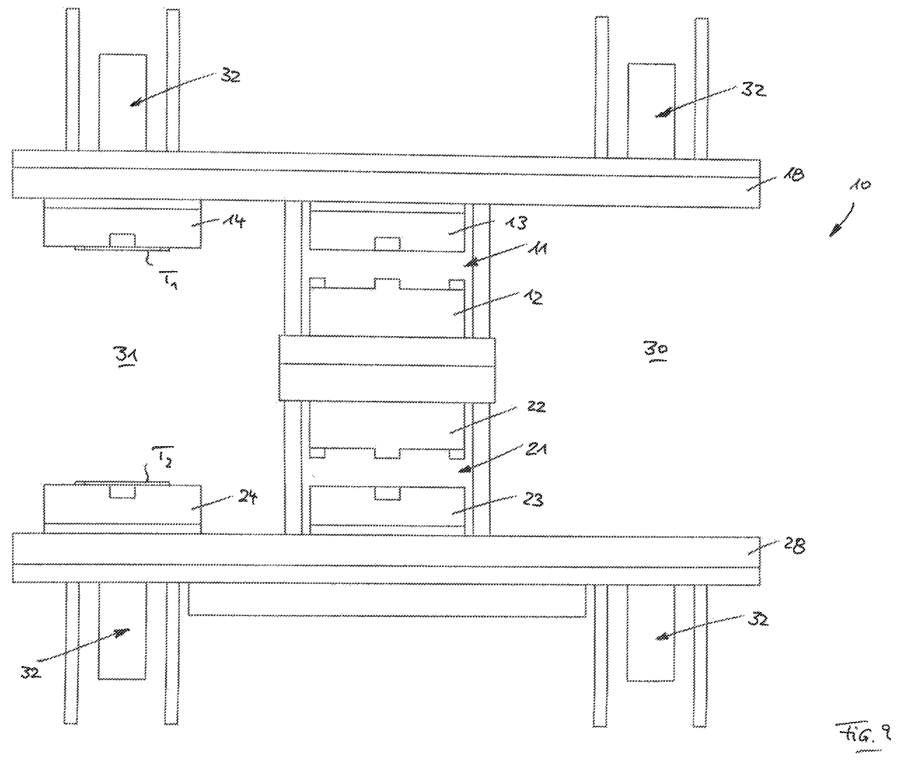

Correspondingly, the additional second mold part 24 is shifted with the molding T2 from the second mold 21 into the second welding station 31 and the second mold part 23 is shifted from the first welding station 30 into the second mold part 21, as it is suggested by the arrows U2 in FIG. 8. The state achieved after the shifting is shown in FIG. 9.

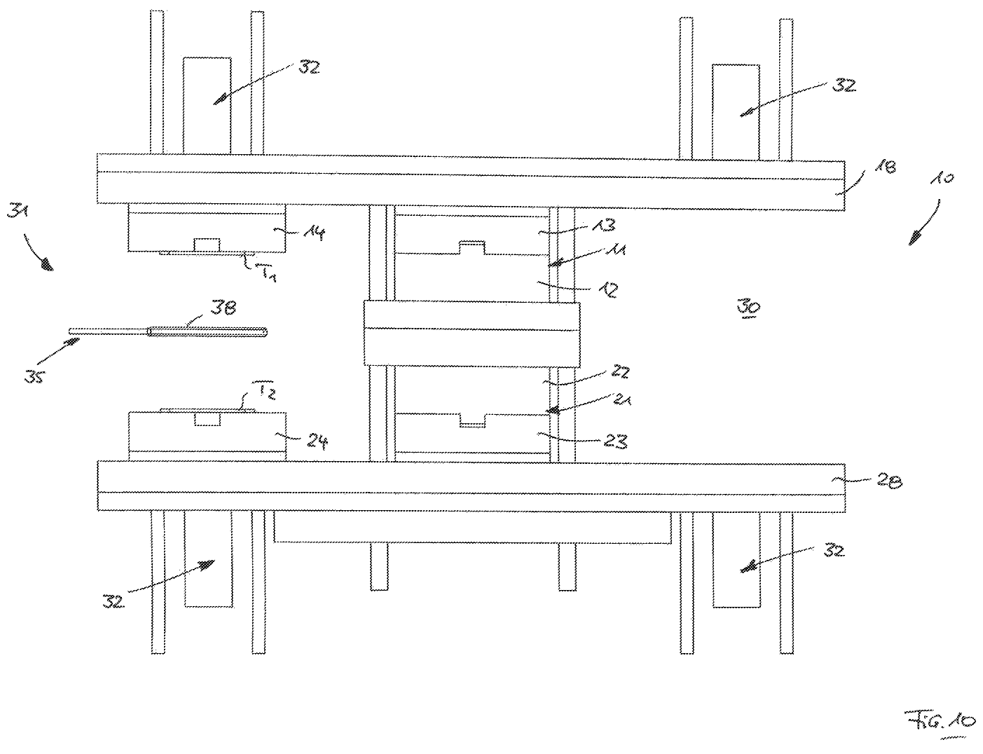

The first support structure 18 and the second support structure 28 are moved towards one another now, as a result of which the molds 11 and 21 are closed again. The additional first mold part 14 with the first molding T1 and the additional second mold part 24 with the second molding T2 are located at mutually spaced locations in the second welding station 31. A heating device 35 in the form of a thin heating plate 38 is inserted between the two molds 14, 24 and between the between these two moldings. This state is shown in FIG. 10.

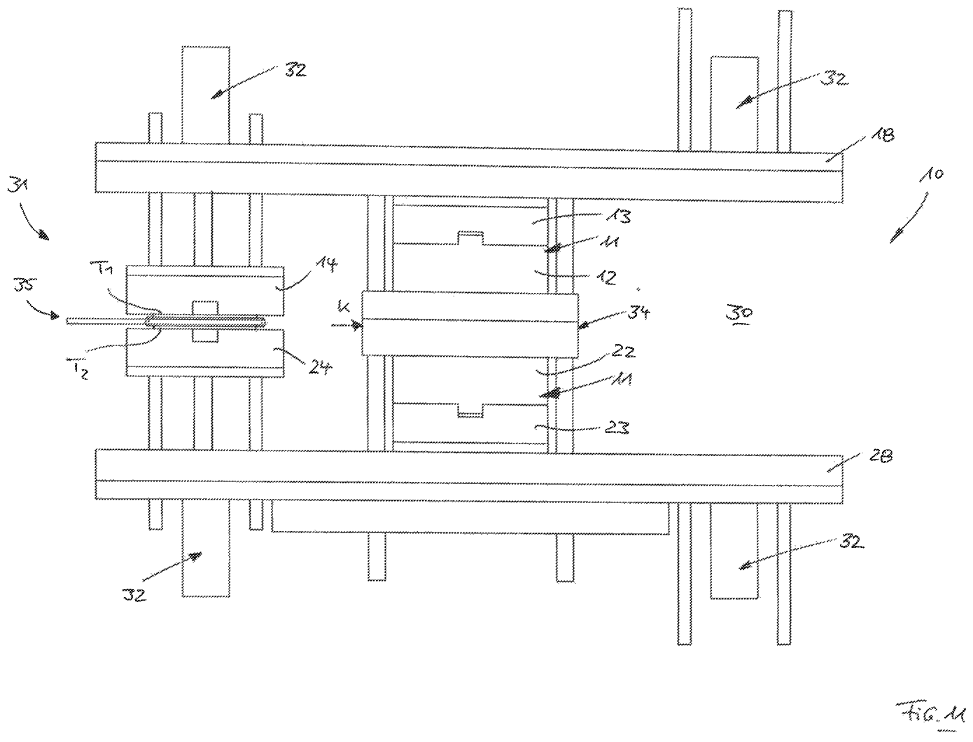

The drive devices 32 associated with the second welding station (second heating station) 31 are then activated such that the additional first mold part 14 and the additional second mold part 24 are moved towards one another to the extent that the moldings T1 and T2 held by them are either arranged very close to the heating device 35 or are in contact with this heating device 35 (FIG. 11). Consequently, the moldings T1 and T2 are heated and especially melted at least at the surfaces facing one another, at which they come into contact with one another during the later welding process.

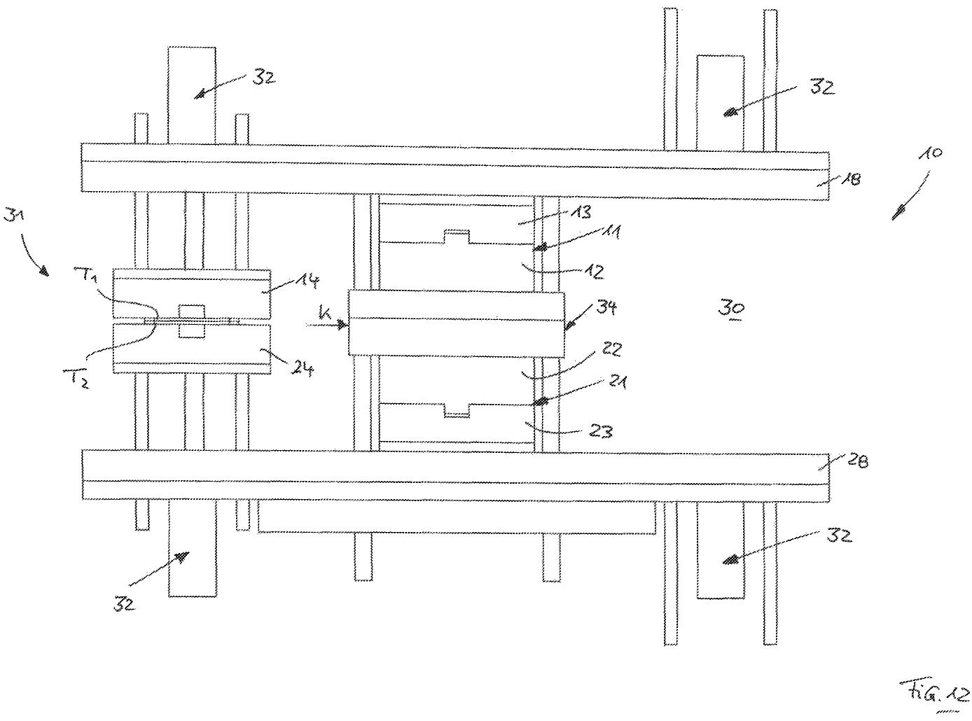

After the moldings T1 and T2 are sufficiently heated, the heating device 35 is removed or moved out and the additional first mold part 14 and the additional second mold part 24 are moved even further towards one another by means of the drive devices 32 until the two moldings T1 and T2 are pressed against one another and are welded together. This state is shown in FIG. 12. At the same time, an additional first molding is manufactured in the first mold 11 and an additional second molding is manufactured in the second mold 21 by the liquid plastic compound being fed in, as it is suggested by the arrow K in FIG. 12.

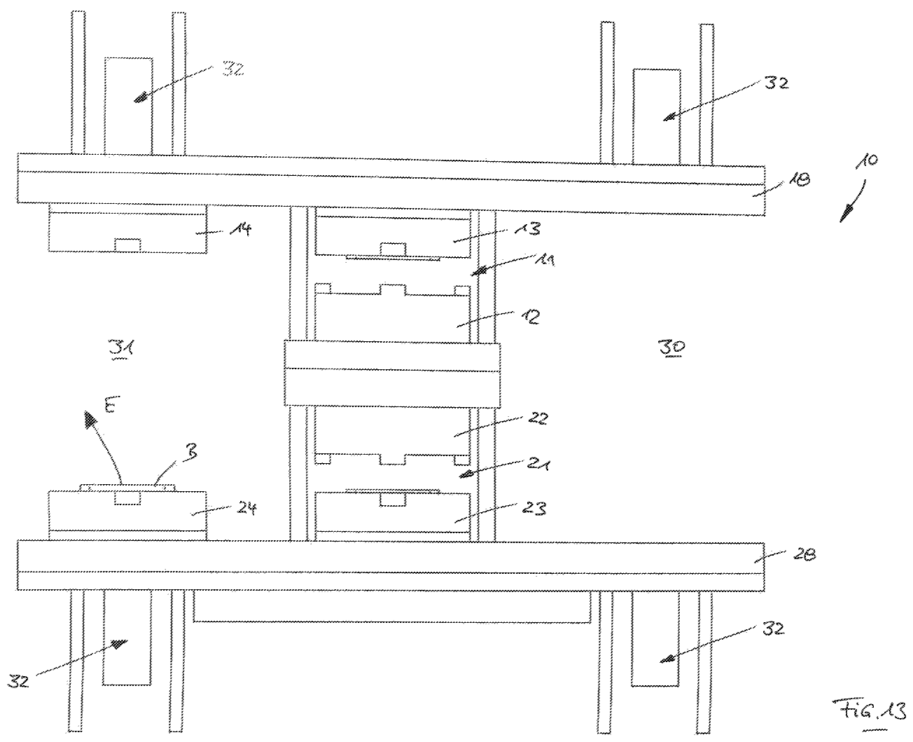

The drive devices 32 are then moved back again, so that the additional first mold part 14 and the additional second mold part 24 are again located in their position close to the first support structure 18 and the second support structure 28, respectively. At the same time, the molds 11 and 21 are moved apart from one another and opened. As FIG. 13 shows, the component formed from the welded moldings is thus now accessible and can be removed, as it is suggested by the arrow E.

It appears from the above description that the moldings T1 and T2 are welded to the component B in the device immediately after the manufacture of the moldings T1 and T2, wherein simultaneously with the welding of the moldings T1 and T2 in one of the welding stations (30, 31), an additional first molding T1 is manufactured in the first mold 11 and an additional second molding T2 is manufactured in the second mold 21, which are then transported into the other welding station in a next step and are welded to the component B there.

While specific embodiments of the invention have been shown and described in detail to illustrate the application of the principles of the invention, it will be understood that the invention may be embodied otherwise without departing from such principles.

What is claimed is:

1. A device for manufacturing a component formed of a plurality of moldings which are made of plastic and are welded together, the device comprising:
a first mold comprising a first mold basic segment and a plurality of first mold parts of the same kind, the first mold parts of the same kind being shiftably mounted with respect to each other to be brought selectively and one after another into contact with the first mold basic segment for forming a first molding cavity therewith;
a second mold comprising a second mold basic segment and a plurality of second mold parts of the same kind, the second mold parts of the same kind being shiftably mounted with respect to each other to be brought selectively and one after another into contact with the second mold basic segment for forming a second molding cavity therewith;
at least one welding station;
a first support structure, the first mold parts of the first mold being shiftably mounted to the first support structure to shift each of the first mold parts between a position in the first mold and a position in the at least one welding station;
a second support structure, the second mold parts of the second mold being shiftably mounted to the second support structure to shift each of the second mold parts between a position in the second mold and a position in the at least one welding station; and
at least one drive device for moving one of the first mold parts of the first mold and one of the second mold parts of the second mold in the welding station towards one another and away from one another in relation to one another whereby a plurality of moldings are welded to form the component between the one of the first mold parts and the one of the second mold parts.

2. A device in accordance with claim 1, wherein the at least one welding station comprises two welding stations.

3. A device in accordance with claim 1, wherein the first mold basic segment of the first mold and the second mold basic segment of the second mold are arranged at a common mold block.

4. A device in accordance with claim 3, wherein the welding stations are arranged on opposite sides of the common mold block.

5. A device in accordance with claim 1, wherein the at least one welding station comprises a heating device for heating the moldings.

6. A process for manufacturing a component formed of a plurality of moldings which are made of plastic and are welded together, the process comprising the steps of:
manufacturing a first molding, by injection molding, in a first mold that comprises a first mold part;
transporting the first molding together with the first mold part, in a state held in the first mold part, into a welding station after opening the first mold;
manufacturing a second molding, by injection molding, in a second mold that comprises a second mold part;
transporting the second molding together with the second mold part, in a state held in the second mold part, into a welding station after opening the second mold; and
moving the first mold part holding the first molding and the second mold part holding the second molding towards one another in relation to one another in the welding station by means of at least one drive device such that the moldings are welded to form the component between the first mold part and the second mold part.

7. A process in accordance with claim 6, wherein the moldings are heated, at least at opposite contact surfaces, by means of a heating device before the welding.

8. A process in accordance with claim 6, wherein an additional first molding is manufactured in the first mold and an additional second molding is manufactured in the second mold simultaneously with the welding of the moldings in the welding station.
